(19) United States
(12) Patent Application Publication
(10) Pub. No.: US 2020/0284334 A1
(43) Pub. Date: Sep. 10, 2020

(54) RACK BAR BLANK MATERIAL, RACK BAR, RACK BAR BLANK MATERIAL MANUFACTURING METHOD, AND RACK BAR MANUFACTURING METHOD

(71) Applicant: NETUREN CO., LTD., Tokyo (JP)

(72) Inventors: Takashi YAMAWAKI, Shinagawa-ku, Tokyo (JP); Kenichi AOKI, Shinagawa-ku, Tokyo (JP)

(73) Assignee: NETUREN CO., LTD., Tokyo (JP)

(21) Appl. No.: 16/648,923

(22) PCT Filed: Oct. 17, 2018
(86) PCT No.: PCT/JP2018/038720

§ 371 Date: Mar. 19, 2020

(30) Foreign Application Priority Data
Oct. 19, 2017 (JP) 2017-202925

(51) Int. Cl. F16H 55/26; B23F 9/08; F16H 25/22

(52) U.S. Cl. CPC F16H 55/26; B62D 3/126; F16H 25/2204; B23F 9/08

(57) ABSTRACT

A rack bar blank material includes a rack portion configured to mesh with a pinion in an end side of a hollow shaft material in an axial direction, and an end portion which is provided closer to the end side of the hollow shaft material than the rack portion. The end portion has a diameter which is larger than that of a minimum circle embracing a section of the rack portion which is perpendicular to the axial direction and which is equal to that of a shaft portion at the other end side of the shaft material in the axial direction.

### TECHNICAL FIELD

The present invention relates to a rack bar blank material, a rack bar, a rack bar blank material manufacturing method and a rack bar manufacturing method.

### BACKGROUND ART

In a known rack bar as a rack bar for use in a rack-and-pinion steering system, a solid shaft material is used, and a plurality of rack teeth are formed on the solid shaft material through cutting or the like. Additionally, a so-called hollow rack bar is also known whose weight is reduced by use of a hollow shaft material.

A hollow rack bar is generally manufactured as below. Firstly, an axial end side of a hollow shaft material is drawn to be formed smaller in diameter than the other axial end side, and a flat collapsed portion having a flat planar shape is provided at part of the formed small-diameter portion. Then, a tooth die is fixed in abutment with an outer surface of the flat collapsed portion, and a mandrel is press fitted in an interior of the flat collapsed portion. The mandrels whose sizes increase gradually are press fitted sequentially one by one, and then, a shape of the tooth die is transferred to the flat collapsed portion as a result of such a press-fit replacement of the mandrels repeatedly, whereby a plurality of rack teeth are formed on the outer surface of the flat collapsed portion (for example, refer to Patent Document 1: JP-A-2016-30271).

In the rack bar manufacturing method of the related art, the individual portions of the rack bar shaft material are finished through grinding after the rack teeth are formed on the outer surface of the flat collapsed portion, and then, a screw groove for a ball screw is formed on an outer surface of a large-diameter portion on the rack bar shaft material. The screw groove is formed by, for example, cutting, during which the rack bar shaft material is rotated with both axial end portions of the shaft material supported rotatably. Thus, the cutting accuracy of the screw groove is affected by the coaxiality of both the end portions of the shaft material and the straightness of the overall shaft material. To cope with this, in the rack bar manufacturing method of the related art, the relevant portions of the shaft material are finished through grinding before the screw groove is formed.

In the rack bar manufacturing method of the related art, however, outside diameters of the end portion on the small-diameter portion side and the end portion on the large-diameter portion side which are supported rotatably differ from each other. This makes it difficult to cut both the end portions simultaneously. Thus, the large-diameter portion including the end portion on the large-diameter portion side and the small-diameter portion including the end portion on the small-diameter portion side are cut separately, and this leaves a problem with a reduction in the number of manufacturing steps. Additionally, there still remains room for improvement in the coaxiality of both the end portions and the straightness of the overall shaft material.

One or more embodiments provide a rack bar improved working accuracy and a simple manufacturing process.

### BRIEF DESCRIPTION OF DRAWINGS

FIG. 1 is a plan view of an example of a rack bar blank material for use for describing an embodiment of the invention.

FIG. 2 is a sectional view of the rack bar blank material shown in FIG. 1.

FIG. 3A is a cross-sectional view taken along a line IIIA-IIIA in FIG. 2.

FIG. 3B is a cross-sectional view taken along a line in FIG. 2.

FIG. 3C is a cross-sectional view taken along a line IIIC-IIIC in FIG. 2.

FIG. 4 is a front view of an example of a rack bar manufactured using the rack bar blank material shown in FIG. 1.

FIG. 5A is a schematic drawing of a step of a manufacturing method of the rack bar blank material shown in FIG. 1.

FIG. 5B is a schematic drawing of another step of the manufacturing method of the rack bar blank material shown in FIG. 1.

FIG. 5C is a schematic drawing of a further step of the manufacturing method of the rack bar blank material shown in FIG. 1.

FIG. 5D is a schematic drawing of a step of the manufacturing method of the rack bar blank material shown in FIG. 1.

FIG. 5E is a schematic drawing of another step of the manufacturing method of the rack bar blank material shown in FIG. 1.

FIG. 5F is a schematic drawing of a further step of the manufacturing method of the rack bar blank material shown in FIG. 1.

FIG. 5G is a schematic drawing of a step of the manufacturing method of the rack bar blank material shown in FIG. 1.

FIG. 5H is a schematic drawing of another step of the manufacturing method of the rack bar blank material shown in FIG. 1.

FIG. 6 is a schematic drawing of an example of an outer diameter grinding performed in FIG. 5H.

FIG. 7 is a schematic drawing of another example of an outer diameter grinding performed in FIG. 5H.

FIG. 8 is a schematic diagram of an example of a manufacturing method of the rack bar shown in FIG. 4.

### MODE FOR CARRYING OUT THE INVENTION

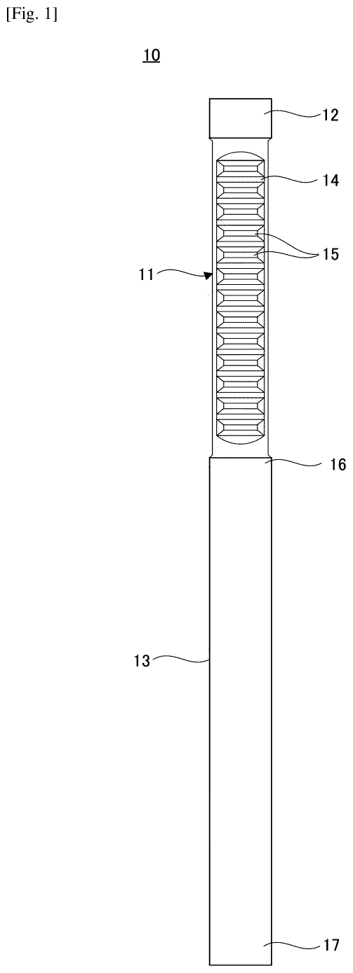

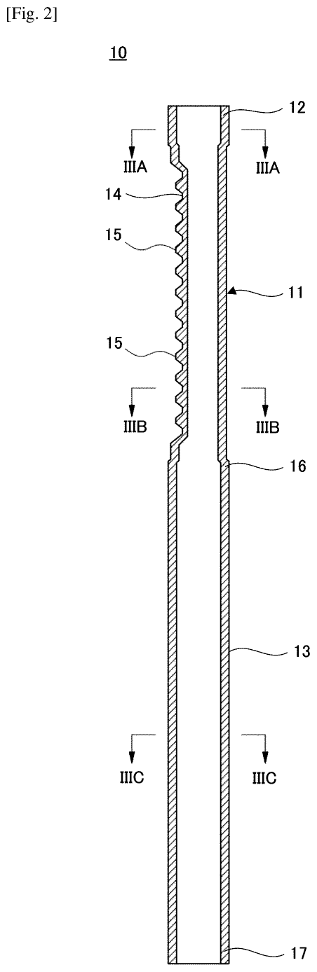

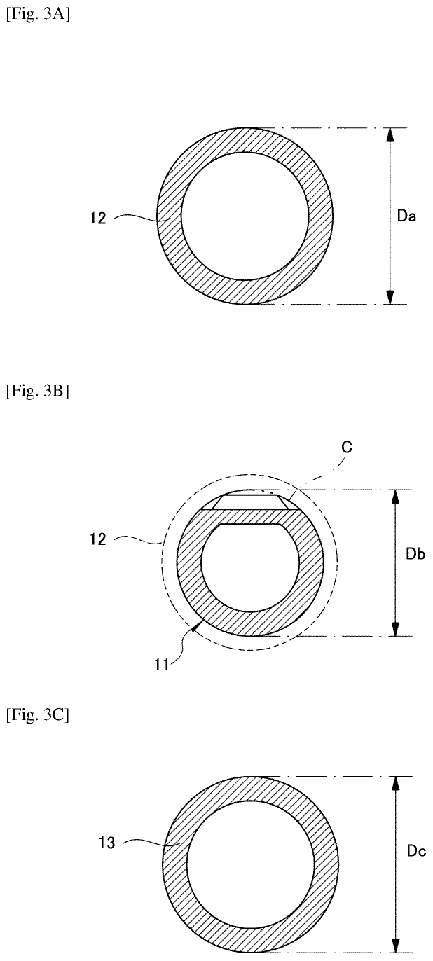

FIG. 1 shows an example of a rack bar blank material for use for describing an embodiment of the invention, and FIGS. 2 and 3A to 3C show a section and cross sections of the rack bar blank material shown in FIG. 1.

A rack bar blank material 10 shown in FIG. 1 is a primarily processed material of a rack bar to be incorporated in, for example, a rack-and-pinion steering system. The rack bar blank material 10 is formed of a hollow shaft material of a metallic material such as steel, for example. The rack bar blank material 10 has, on an axial end side thereof, a rack portion 11 and an end portion 12 which is provided closer to the axial end side of the shaft material than the rack portion 11 and has a shaft portion 13 on the other axial end side.

The rack portion 11 has a flat collapsed portion 14 extending in an axial direction and a plurality of rack teeth 15 provided on an outer circumferential surface of the flat collapsed portion 14. The rack portion 11 meshes with a pinion via these rack teeth 15. In this embodiment, the rack teeth 15 have a constant pitch and provide a constant gear ratio (CGR). However, the pitch may vary to thereby provide a variable gear ratio (VGR).

The shaft portion 13 is supported by a housing of the steering system so as to move in the axial direction. An axial direction acting element may be provided on the shaft portion 13 in addition to the rack portion 11.

A heat treatment including at least hardening is applied to the rack portion 11 and the shaft portion 13 except an intermediate portion 16 defined between the rack portion 11 and the shaft portion 13.

As shown in FIGS. 3A to 3C, an outside diameter Da of the end portion 12 of the rack bar blank material 10 is larger than a diameter Db of a minimum circle C embracing the rack portion 11 in a cross section taken perpendicular to the axial direction (Da>Db) and is equal to an outside diameter Dc of the shaft portion 13 (Da=Dc).

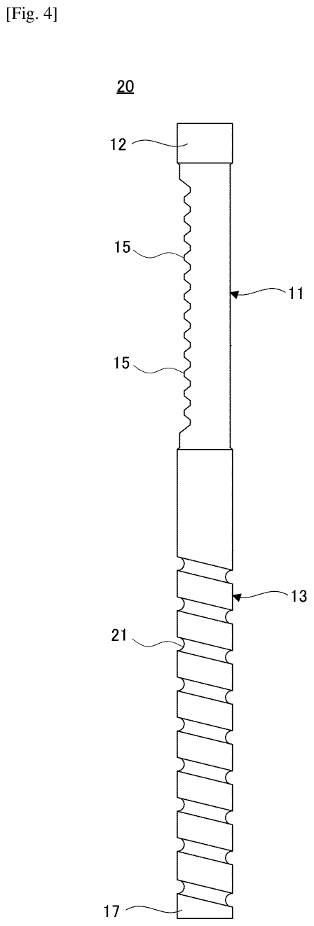

FIG. 4 shows an example of a rack bar manufactured by use of the rack bar blank material 10.

A rack bar 20 shown in FIG. 4 has the rack portion 11 formed in the stage where the rack bar blank material 10 is manufactured on an axial end side and has a screw groove 21 for a ball screw as another axial direction acting element, and the screw groove 21 is formed on an outer circumferential surface of the shaft portion 13.

Although its illustration is omitted, a female thread is formed individually on the end portion 12 on the rack portion 11 side and an end portion 17 of the shaft portion 13 side, and a ball joint which is coupled with a tie-rod of the steering system is connected to the female thread. These female threads may be formed in the state where the rack bar blank material 10 is manufactured.

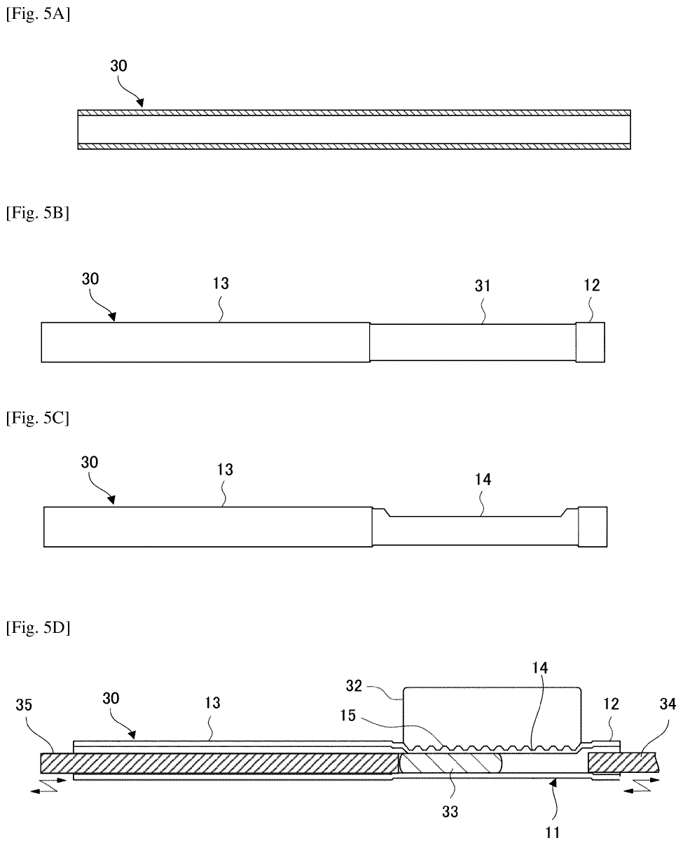

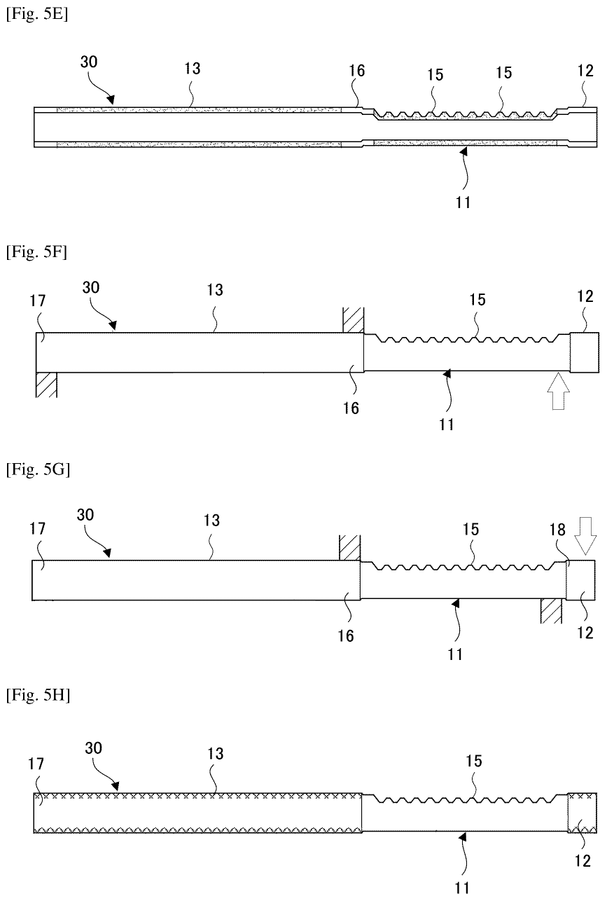

FIGS. 5A to 5H shows an example of a manufacturing method of the rack bar blank material 10.

### <Pre-Forming Step>

As shown in FIG. 5A, a hollow shaft material 30 is used to manufacture the rack bar blank material 10. The shaft material 30 has a cylindrical shape whose outside diameter and inside diameter are constant over a full length of the shaft material 30 in an axial direction thereof.

As shown in FIG. 5B, a small-diameter portion 31 is formed at a portion on an axial end side of the shaft member 30 through rolling, drawing such as swaging, cutting or the like, whereby an end portion 12 which is relatively large in diameter is formed at a portion lying closer to the end side than the small-diameter portion 31. The end portion 12 keeps the original diameter of the shaft material 30 and has the same outside diameter as that of a shaft portion 13 on the other axial end side of the shaft material 30.

### <Teeth Forming Step>

Next, as shown in FIG. 5C, a circumferential portion of the small-diameter portion 31 of the shaft material 30 is collapsed to be flat through pressing, whereby a flat collapsed portion 14 extending in an axial direction of the shaft material 30 is formed. Thereafter, as required, a forming treatment is applied to the shaft material 30 in which a phosphate layer is formed on a surface of the shaft material 30. Then, a plurality of rack teeth 15 are formed on the flat collapsed portion 14.

The plurality of rack teeth 15 are formed as below. As shown in FIG. 5D, a tooth die 32 is fixed in such a state that the tooth die 32 is in abutment with an outer surface of the flat collapsed portion 14, and a mandrel 33 is press fitted in an interior of the flat collapsed portion 14 by a push rod 34 through an opening at an end of the end portion 12. Then, the mandrel 33 press fitted is then pushed back by a push rod 35 to thereby be discharged from the shaft material 30.

The material of the flat collapsed portion 14 is worked by the mandrel 33 so plied while the mandrel 33 is reciprocated over a full length of the flat collapsed portion 14 and flows plastically towards the tooth die 32. Mandrels 33 which are gradually increased in diameter are used to be press fitted into the flat collapsed portion 14 repeatedly, causing the material of the flat collapsed portion 14 to bite into the tooth die 32, whereby the shape of the tooth die 32 is transferred onto the flat collapsed portion 14, and a plurality of rack teeth 15 are formed on the flat collapsed portion 14.

As the rack portion 11 (the flat collapsed portion 14 and the plurality of rack teeth 15) is worked plastically, a bend may be generated in the shaft material 30, and hence, the bend of the shaft material 30 may be corrected as required after the teeth forming step.

### <Heat Treatment Step>

Next, as shown in FIG. 5E, to enhance the hardness of the rack portion 11 configured to mesh with a pinion and the shaft portion 13 which is supported movably in a housing of a steering system, hardening is applied to the rack portion 11 and the shaft portion 13. However, in consideration of a possibility that a bend generated in the shaft material 30 is corrected in a correction step, which will be described later, the intermediate portion 16 between the rack portion 11 and the shaft portion 13 is left not hardened. To heat the rack portion 11 and the shaft portion 13 for hardening, for example, high-frequency induction heating can be made use of, however, the invention is not limited to the high-frequency induction heating.

To recover the toughness of the rack portion 11 and the shaft portion 13 to which the hardening is applied, tempering may be applied locally to the rack portion 11 and the shaft portion 13 or may be applied to the whole of the shaft material 30. To remove an oxide layer generated on the surface of the shaft material 30 as a result of the heat treatment such as hardening being applied to the surface, shot-peening may be applied. This shot-peening may be applied locally only to the rack portion 11 except the shaft portion 13 to which outside diameter grinding is applied in a post-step, for example or may be applied to the whole of the shaft material 30.

### <Correction Step>

Next, a bend generated in the shaft member 30 by the heat treatment such as hardening is corrected.

Since the intermediate portion 16 between the rack portion 11 and the shaft portion 13 is left not hardened in the heat treatment step, the intermediate portion 16 is relatively easy to be bent. As shown in FIG. 5F, for example, with the intermediate portion 16 and the end portion 17 on the shaft portion 13 side supported, a load is exerted on the rack portion 11, whereby the intermediate portion 16 is bent as required. This enhances the straightness of the rack portion 11 with respect to the shaft portion 13, whereby the coaxiality of the end portion 17 on the shaft portion 13 side with the end portion 12 on the rack portion 11 side is also enhanced.

Preferably, a connecting portion 18 between the end portion 12 and the rack portion 11 is bent further. Since the connecting portion 18 is also left not hardened, the connecting portion 18 is relatively easy to be bent as with the intermediate portion 16. As shown in FIG. 5G, for example, with the connecting portion 18 and the intermediate portion 16 supported, the connecting portion 18 is bend as required by applying a load on the end portion 12. This enhances further the straightness of the shaft material 30 and the coaxiality of the end portion 17 on the shaft portion 13 side with the end portion 12 on the rack portion 11 side.

After the correction step, as required, the plurality of rack teeth 15 are inspected, a tooth rear surface of the rack portion 11 positioned on an opposite side to the side where the plurality of rack teeth 15 are formed is abraded, and the shaft material 30 is inspected magnetically for a flaw. In addition, a female thread is formed on the end portion 12 on the rack portion 11 side and the end portion 17 on the shaft portion 13 side as required.

### <Grinding Step>

Next, as shown in FIG. 5H, an outer diameter grinding is applied to the end portion 12 on the rack portion 11 side and the shaft portion 13 including the end portion 17 of the shaft material 30 which is corrected to free from a bend. Here, the end portion 12 keeps its diameter which remains the same as that of the shaft material 30 through the pre-forming step to the correction step and has an outside diameter which is the same as that of the shaft portion 13. When an outer diameter grinding is applied to this end portion 12, the outer diameter grinding is applied to the end portion 12 and at least part of the shaft portion 13 at the same time.

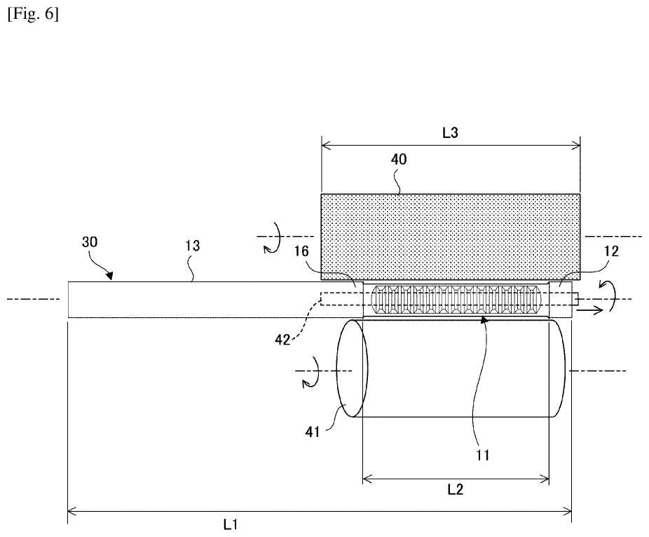

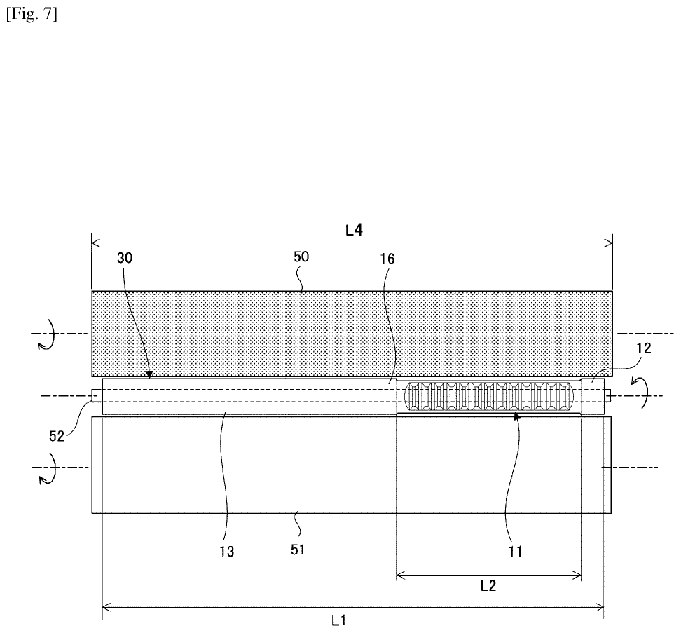

FIGS. 6 and 7 show examples of the outer diameter grinding.

For example, a centerless grinding can be used when the outer diameter grinding is applied to the end portion 12 and the shaft portion 13, and the centerless grinding includes a trough-feed grinding (a through-feed grinding) and an infeed grinding (a stop grinding).

FIG. 6 shows schematically an example of the trough-feed grinding, in which the shaft material 30 is supported by a grinding wheel 40, a control wheel 41 and a support blade 42. When the grinding wheel 40 and the control wheel 41 are rotated, with a center axis of the control wheel 41 inclined with respect to a center axis of the shaft material 30 and a center axis of the grinding wheel 40, the shaft material 30 which is held by the grinding wheel 40 and the control wheel 41 on the support blade 42 is fed in the axial direction while being rotated. An overall length G3 of the grinding wheel 40 is smaller than an overall length L1 of the shaft material 30, and an outer circumferential surface of the shaft material 30 which is in contact with the grinding wheel 40 is ground continuously while the shaft material 30 is being fed in the axial direction. In this through-feed grinding, since the overall length L3 of the grinding wheel 40 is larger than an axial length L2 of the rack portion 11, and the grinding wheel 40 has such a length that the grinding wheel 40 extends between the end portion 12 and the intermediate portion 16 between which the rack portion 11 is held, the end portion 12 and part of the shaft portion 13 are ground externally and outer circumferentially at the same time.

FIG. 7 shows schematically an example of the infeed grinding, in which the shaft material 30 is supported by a grinding wheel 50, a control wheel 51 and a support blade 52 in a similar way to that used in the through-feed grinding shown in FIG. 6. However, the infeed grinding differs from the through-feed grinding in that an overall length L4 of the grinding wheel 50 is equal to or larger than the overall length L1 of the shaft material 30, a center axis of the control wheel 51 is disposed parallel to the center axis of the shaft material 30 and a center axis of the grinding wheel 50, and the axial feeding of the shaft material 30 is stopped, and the end portion 12 and the whole of the shaft portion 13 are ground externally and outer circumferentially.

The outer diameter grinding applied to the end portion 12 and the shaft portion 13 is not limited to the centerless grinding. For example, an external cylindrical grinding can also be used in which the shaft material is supported at its axis at both ends of the shaft material. For the external cylindrical grinding, either of a traverse grinding in which the shaft material 30 is fed in the axial direction as with the through-feed grinding and a plunge grinding in which the axial feeding of the shaft material 30 is stopped as with the infeed grinding may be used.

Since the end portion 12 keeps its diameter equal to the diameter of the shaft material 30 which is the diameter of the material of the rack bar blank material 10 and has the outside diameter equal to that of the shaft portion 13, when the end portion 12 and at least part of the shaft portion 13 are ground at the same time, the end portion 12 and the shaft portion 13 are brought into contact with the grinding wheel uniformly. This can enhance the coaxiality between the end portion 12 on the rack portion 11 side and the end portion 17 on the shaft portion 13 side of the rack bar blank material 10 which is manufactured through the pre-forming step to the grinding step and the straightness of the whole of the rack bar blank material 10, thereby making it possible to simplify the manufacturing process.

In particular, in this embodiment, the bend generated in the shaft material 30 is corrected in the correction step, whereby the end portion 12 and the shaft portion 13, which are ground externally and outer circumferentially, are brought into a contact with the grinding wheel more uniformly, and this can enhance further the coaxiality between both the end portions 12, 17 and the straightness of the whole of the shaft material 30.

From the view point of enhancing the coaxiality between the end portion 12 on the rack portion 11 side and the end portion 17 on the shaft portion 13 side and the straightness of the whole of the shaft material 30, of the through-feed grinding and the infeed grinding, the infeed grinding is preferable in which the end portion 12 and the whole of the shaft portion 13 are ground externally and outer circumferentially at the same time.

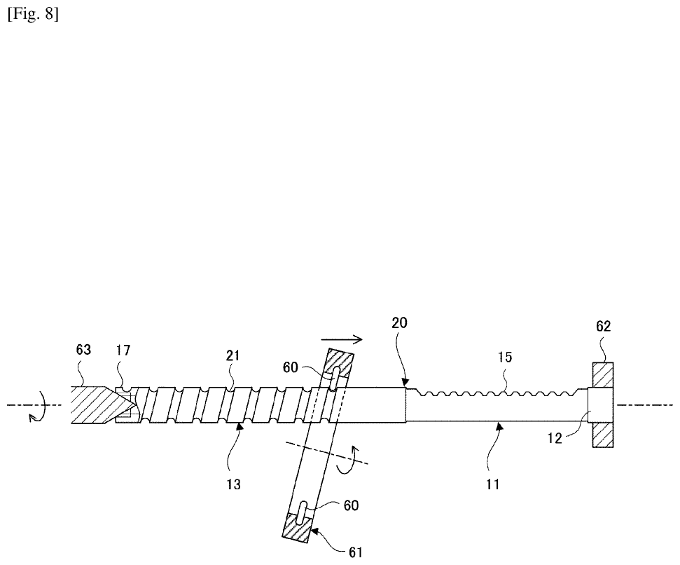

FIG. 8 shows an example of a manufacturing method of a rack bar 20.

A rack bar 20 has the rack portion 11, which is formed in the stage where the rack bar blank material 10 is formed, on an axial end side and the screw groove 21 of the ball screw as another axial direction acting element on the other axial end side thereof, as described above. The screw groove 21 is formed on the outer circumferential surface of the shaft portion 13 of the rack bar blank material 10 through whirling or the like.

An annular cutting tool 61 is used in whirling in which a plurality of cutting tips 60 are disposed at constant intervals in a circumferential direction on an inner circumferential portion of the annular cutting tool 61. The rack bar blank material 10 is inserted through the annular cutting tool 61, and the end portion 12 on the rack portion 11 side and the end portion 17 on the shaft portion 13 side are supported rotatably by a chuck 62 and a center 63. The cutting tool 61 is disposed eccentric and inclined with respect to the rack bar blank member 10. When the cutting tool 61 is rotated, the plurality of cutting tips 60 cut sequentially the outer circumferential surface of the shaft portion 13, and when the rack bar blank member 10 is rotated and the cutting tool 61 is caused to index in the axial direction of the rack bar blank material 10, the spiral screw groove 21 is formed on the outer circumferential surface of the shaft portion 13.

Since the coaxiality between the end portion 12 on the rack portion 11 side and the end portion 17 on the shaft portion 13 side of the rack bar blank material 10 and the straightness of the rack bar blank material 10 are enhanced, the run-out of the rack bar blank material 10 which is being rotated with both the end portions 12, 17 supported rotatably is prevented. This enhances the forming accuracy of the screw groove 21, that is, the working accuracy of the rack bar 20.

A direct acting element in the axial direction provided on the shaft portion 13 is not limited to the screw groove 21 of the ball screw and hence may be a rack. A separate hollow or solid shaft material on which a rack is formed in advance is joined to an end face of the shaft portion 13 of the rack bar blank material 10, whereby a rack is provided on the shaft portion 13. Then, the separate shaft material and the rack bar blank material 10 can be joined together, for example, through frictional press fitting in which the separate shaft material is pressed against the end face of the shaft portion 13 while rotating the rack bar blank material 10. Then, since the run-out of the rotating rack bar blank material 10 is suppressed, the coaxiality between the separate shaft material and the rack bar blank material 10 and the straightness of the rack bar are enhanced, that is, the working accuracy of the rack bar is enhanced.

Thus, as has been described heretofore, the rack bar blank material disclosed in this description has the rack portion configured to mesh with a pinion in an end side of a hollow shaft material in an axial direction than the rack portion, and an end portion which is provided closer to the end side of the hollow shaft material than the rack portion. The end portion has a diameter which is larger than that of a minimum circle embracing a section of the rack portion which is perpendicular to the axial direction and which is equal to that of a shaft portion at the other end side of the hollow shaft material in the axial direction.

In the rack bar blank material disclosed in this description, the rack portion and the shaft portion are hardened except an intermediate portion between the rack portion and the shaft portion.

The rack bar disclosed in this description includes an axial direction acting element provided on the shaft portion of the rack bar blank material.

In the rack bar disclosed in this description, the direct acting element is a screw groove of a ball screw and is provided on an outer circumferential surface of the shaft portion.

The rack bar blank material manufacturing method disclosed in this description includes a pre-forming that forms a small-diameter portion on an end side of a hollow shaft material in an axial direction and an end portion provided closer to the end side of the hollow shaft material in the axial direction than the small-diameter portion and having a diameter which is larger than that of the small-diameter portion and which is equal to that of a shaft portion on the other end side of the hollow shaft material in the axial direction, a tooth forming that forms a rack portion configured to mesh with a pinion on the small-diameter portion, and a grinding that applies an outer diameter grinding to the end portion and the shaft portion, the outer diameter grinding being applied simultaneously to at least part of the shaft portion when the outer diameter grinding is applied to the end portion.

The rack bar blank material manufacturing method disclosed in this description includes heat treatment that hardens the rack portion and the shaft portion except an intermediate portion between the rack portion and the shaft portion, after the tooth forming and before the grinding.

The rack bar blank material manufacturing method disclosed in this description includes correction that bends the intermediate portion between the rack portion and the shaft portion of a rack bar blank material so as to correct the rack portion and the shaft portion to be straight, before the grinding.

In the rack bar blank material manufacturing method disclosed in this description, the correction includes a further bending the connecting portion of the end portion connecting to the rack portion so as to correct the end portion, the rack portion and the shaft portion to be straight in the correction.

In the rack bar manufacturing method disclosed in this description, the rack bar manufacturing method includes providing an axial direction acting element on the shaft portion while rotatably supporting the end portion and the shaft portion of the rack bar blank material and rotating the rack bar blank material.

In the rack bar manufacturing method disclosed in this description, a screw groove of a ball screw is formed on an outer circumferential surface of the shaft portion as the direct acting element.

This application claims priority to Japanese Patent Application No. 2017-202925 filed on Oct. 19, 2017, the entire content of which is incorporated herein by reference.

1. A rack bar blank material comprising:
a rack portion configured to mesh with a pinion in an end side of a hollow shaft material in an axial direction; and
an end portion which is provided closer to the end side of the hollow shaft material than the rack portion,
wherein the end portion has a diameter which is larger than that of a minimum circle embracing a section of the rack portion which is perpendicular to the axial direction and which is equal to that of a shaft portion at the other end side of the hollow shaft material in the axial direction.

2. The rack bar blank material according to claim 1,
wherein the rack portion and the shaft portion are hardened except an intermediate portion between the rack portion and the shaft portion.

3. A rack bar comprising:
a direct acting element in the axial direction provided on the shaft portion of the rack bar blank material according to claim 1.

4. The rack bar according to claim 3,
wherein the direct acting element is a screw groove of a ball screw and is provided on an outer circumferential surface of the shaft portion.

5. A rack bar blank material manufacturing method comprising:
a pre-forming that forms a small-diameter portion on an end side of a hollow shaft material in an axial direction and an end portion provided closer to the end side of the hollow shaft material in the axial direction than the small-diameter portion and having a diameter which is larger than that of the small-diameter portion and which is equal to that of a shaft portion on the other end side of the hollow shaft material in the axial direction;
a tooth forming that forms a rack portion configured to mesh with a pinion on the small-diameter portion; and
a grinding that applies an outer diameter grinding to the end portion and the shaft portion, the outer diameter grinding being applied simultaneously to at least part of the shaft portion when the outer diameter grinding is applied to the end portion.

6. The rack bar blank material manufacturing method according to claim 5, further comprising:
a heat treatment that hardens the rack portion and the shaft portion except an intermediate portion between the rack portion and the shaft portion, after the tooth forming and before the grinding.

7. The rack bar blank material manufacturing method according to claim 6, further comprising:
a correction that bends the intermediate portion between the rack portion and the shaft portion of a rack bar blank material so as to correct the rack portion and the shaft portion to be straight, before the grinding.

8. The rack bar blank material manufacturing method according to claim 7,
wherein the correction includes a further bending the connecting portion of the end portion connecting to the rack portion so as to correct the end portion, the rack portion and the shaft portion to be straight in the correction.

9. A rack bar manufacturing method comprising:
providing an axial direction acting element on the shaft portion while rotatably supporting the end portion and the shaft portion of the rack bar blank material according to claim 1 and rotating the rack bar blank material.

10. The rack bar manufacturing method according to claim 9,
wherein a screw groove of a ball screw is formed on an outer circumferential surface of the shaft portion as the direct acting element.

11. A rack bar comprising:
a direct acting element in the axial direction provided on the shaft portion of the rack bar blank material according to claim 2.

12. A rack bar manufacturing method comprising:
providing an axial direction acting element on the shaft portion while rotatably supporting the end portion and the shaft portion of the rack bar blank material according to claim 2 and rotating the rack bar blank material.
